(19) United States
(12) Patent Application Publication
(10) Pub. No.: US 2026/0099069 A1
(43) Pub. Date: Apr. 9, 2026

(54) DISPLAY DEVICE AND FRONT FRAME THEREOF

(71) Applicant: QISDA CORPORATION, Taoyuan City (TW)

(72) Inventor: Jen-Kai Lu, Taoyuan City (TW)

(73) Assignee: QISDA CORPORATION, Taoyuan City (TW)

(21) Appl. No.: 19/248,399

(22) Filed: Jun. 24, 2025

(30) Foreign Application Priority Data
Oct. 9, 2024 (CN) 202411399039.5

(51) Int. Cl. G02F 1/1333

(52) U.S. Cl. CPC G02F 1/13332; G02F 1/133314; G02F 1/133322

(57) ABSTRACT

A display device includes a display module, a transparent sheet, a front frame, and a back cover. The front frame accommodates the display module and includes a connection frame portion and a side frame portion. The connection frame portion is attached to the transparent sheet to make the transparent sheet cover a front surface of the display module. The side frame portion includes a frame hook protruding outwardly relative to the display module. The side frame portion forms a plurality of through holes between the frame hook and the connection frame portion. The plurality of through holes is formed at intervals along the side frame portion. The back cover is disposed on a back surface of the display module and accommodates the front frame. The back cover includes a cover hook protruding inwardly corresponding to the frame hook. The frame hook is engaged with the cover hook.

### BACKGROUND OF THE INVENTION

### 1. FIELD OF THE INVENTION

The present invention relates to a display device and a front frame thereof, and more specifically, to a display device forming a recessed section or through holes arranged at intervals on a front frame at a position corresponding to a frame hook and a front frame thereof.

### 2. DESCRIPTION OF THE PRIOR ART

In general, a display device on the market usually attaches a front frame directly to a transparent glass sheet of a display panel and then accommodates the display panel in a casing formed by the front frame and a back cover via structural engagement between a frame hook and a cover hook, so as to complete assembly of the display device and achieve a narrow bezel effect.

However, due to inaccurate manufacturing tolerances between the front frame and the back cover, the frame hook could be pulled or pressed to deform by the cover hook easily after the front frame and the back cover are assembled, which could indirectly cause deformation of the transparent glass sheet attached to the front frame (e.g., wave-like deformation). As such, light leakage in the display panel occurs at positions corresponding to the aforesaid deformation of the transparent glass sheet, so as to significantly affect the image display quality of the display device.

### SUMMARY OF THE INVENTION

The present invention provides a display device including a display module, a transparent sheet, a front frame and a back cover. The front frame accommodates the display module and includes a connection frame portion and a side frame portion. The connection frame portion is attached to the transparent sheet to make the transparent sheet cover a front surface of the display module. The side frame portion includes a frame hook protruding outwardly relative to the display module. The side frame portion forms a plurality of through holes between the frame hook and the connection frame portion, and the plurality of through holes is formed at intervals along the side frame portion. The back cover is disposed on a back surface of the display module and accommodates the front frame. The back cover includes a cover hook protruding inwardly corresponding to the frame hook. The frame hook is engaged with the cover hook.

The present invention further provides a display device including a display module, a transparent sheet, a back cover, and a front frame. The back cover is disposed on a back surface of the display module. A cover hook protrudes laterally from the back cover toward the display module. The front frame is stacked with the back cover and accommodates the display module. The front frame includes a connection frame portion and a side frame portion. The connection frame portion is attached to the transparent sheet to make the transparent sheet cover a front surface of the display module. The side frame portion includes a recessed section and a frame hook corresponding to the cover hook. The frame hook is positioned on a side of the recessed section opposite to the display module and faces the back cover. A thickness of the recessed section gradually decreases from two ends of the recessed section toward the frame hook. The cover hook is engaged with the frame hook.

The present invention further provides a front frame for being engaged with a back cover and attached to a transparent sheet to accommodate a display module. The back cover is disposed on a back surface of the display module and includes a cover hook protruding laterally toward the display module. The front frame includes a connection frame portion and a side frame portion. The connection frame portion is attached to the transparent sheet to make the transparent sheet cover a front surface of the display module. The side frame portion includes a frame hook corresponding to the cover hook and forms a plurality of through holes between the frame hook and the connection frame portion. The plurality of through holes is formed at intervals along the side frame portion. The frame hook is engaged with the cover hook.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partially-exploded diagram of a display device according to an embodiment of the present invention.

FIG. 2 is a partial cross-sectional diagram of the display device in FIG. 1 after assembly along a cross-sectional line A-A.

FIG. 3 is a partially-enlarged diagram of a front frame from another viewing angle.

FIG. 4 is a cross-sectional diagram of the front frame in FIG. 3 along a cross-sectional line B-B.

FIG. 5 is a partially-enlarged diagram of a front frame according to another embodiment of the present invention.

FIG. 6 is a partially-enlarged diagram of the front frame corresponding to a frame hook.

FIG. 7 is a cross-sectional diagram of the front frame in FIG. 6 along a cross-sectional line C-C.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., structural designs and sizes of a frame hook, through holes and a recessed section, and a hook engagement design) in the drawings is merely illustrative, not presenting an actual condition of the embodiments.

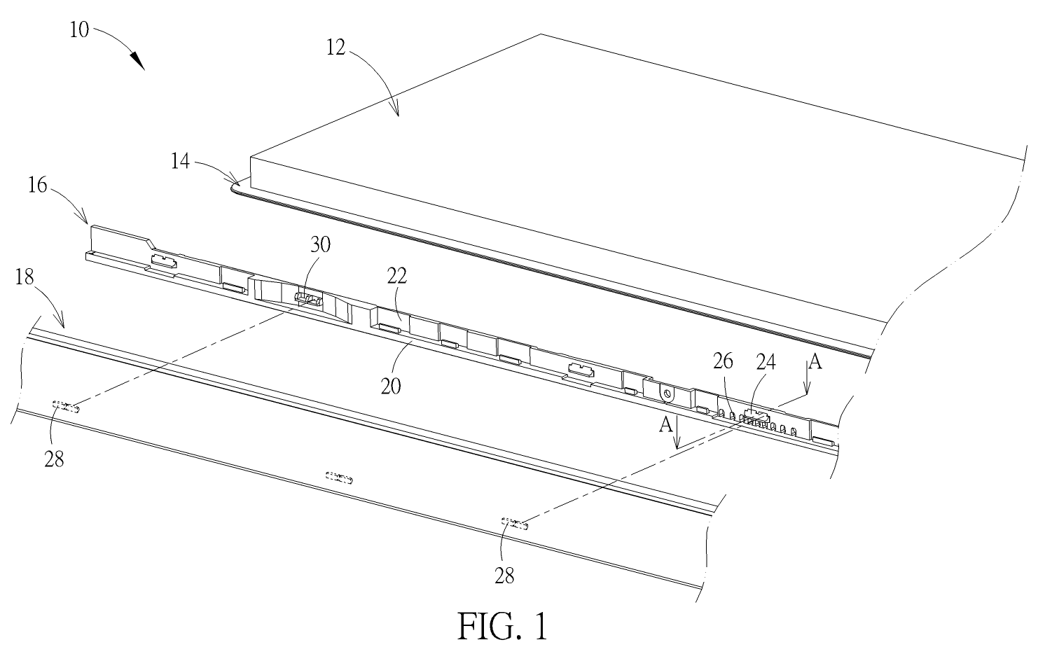

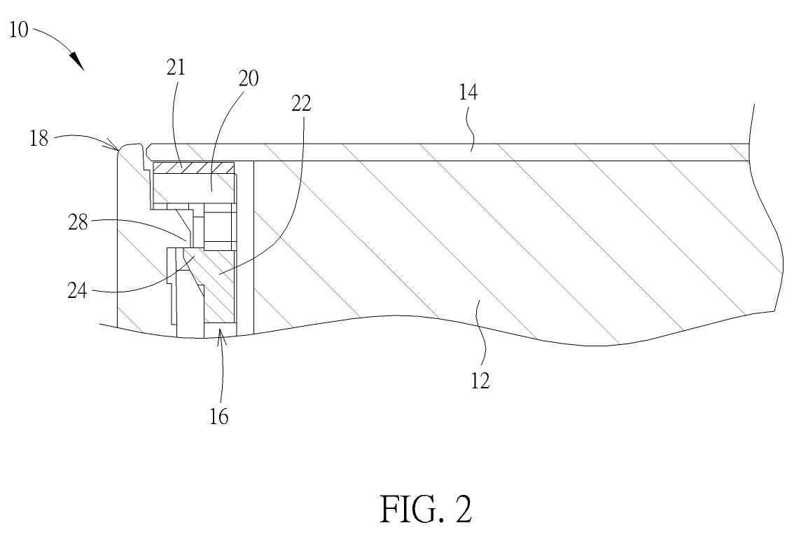

Please refer to FIGS. 1 and 2. FIG. 1 is a partially-exploded diagram of a display device 10 according to an embodiment of the present invention. FIG. 2 is a partial cross-sectional diagram of the display device 10 in FIG. 1 after assembly along a cross-sectional line A-A. For clearly showing a structural design of a front frame 16, only frame structures of the front frame 16 and a back cover 18 are shown in FIG. 1, and the related description for the other structures of the front frame 16 and the back cover 18 is commonly seen in the prior art and omitted herein. As shown in FIGS. 1 and 2, the display device 10 could be preferably a narrow-bezel display monitor (e.g., an LCD television or LCD computer monitor, but not limited thereto) and includes a display module 12 (i.e., an LCD display panel (the related description is commonly seen in the prior art and omitted herein)), a transparent sheet 14 (preferably a transparent glass sheet, but not limited thereto), the front frame 16, and the back cover 18. The front frame 16 accommodates the display module 12 and includes a connection frame portion 20 and a side frame portion 22. The connection frame portion 20 is attached to the transparent sheet 14 (e.g., by an adhesive 21 as shown in FIG. 2), so that the transparent sheet 14 can cover a front surface of the display module 12 for panel protection. The side frame portion 22 includes a frame hook 24 protruding outward relative to the display module 12. A plurality of through holes 26 is formed in the side frame portion 22 between the frame hook 24 and the connection frame portion 20 (nine shown in FIG. 1, but not limited thereto, meaning that the number of through holes may vary depending on the actual manufacturing requirements of the display device 10). The through holes 26 are arranged at intervals along the side frame portion 22. The back cover 18 is disposed on a back surface of the display module 12 and accommodates the front frame 16. The back cover 18 includes a cover hook 28 protruding inwardly at a position corresponding to the frame hook 24. In such a manner, the frame hook 24 can be engaged with the cover hook 28 (as shown in FIG. 2) for connecting the back cover 18 to the front frame 16 attached to the transparent sheet 14, such that the transparent sheet 14, the front frame 16, and the back cover 18 can accommodate the display module 12 together, thereby completing assembly of the display device 10.

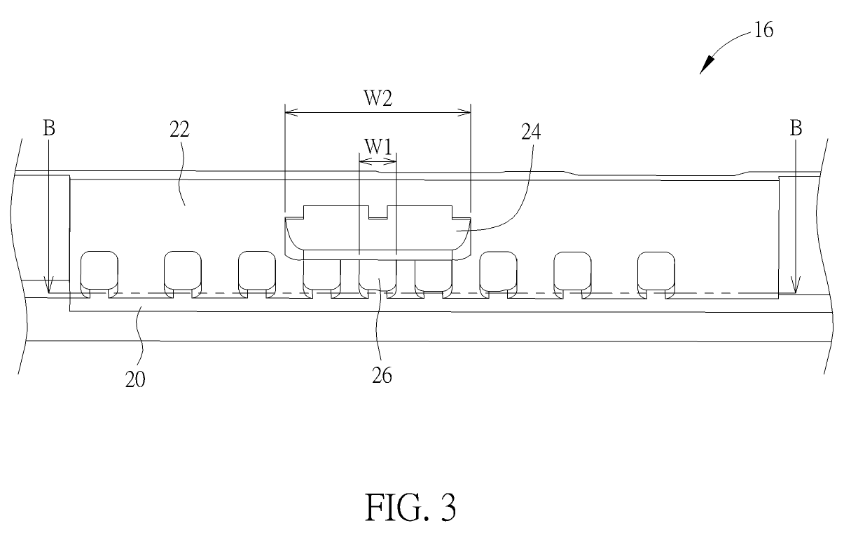

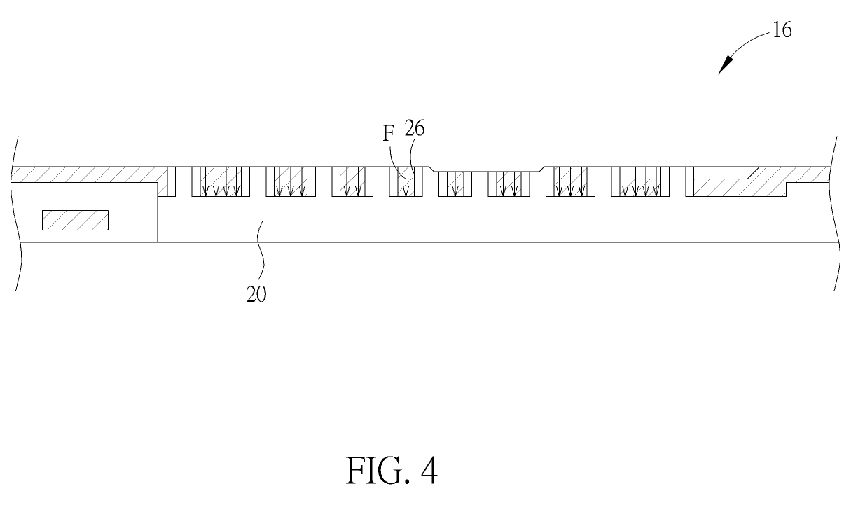

To be more specific, the hole configuration in the front frame 16 can adopt a gradually-increasing interval design. For example, please refer to FIGS. 2, 3, and 4. FIG. 3 is a partially-enlarged diagram of the front frame 16 from another viewing angle. FIG. 4 is a cross-sectional diagram of the front frame 16 in FIG. 3 along a cross-sectional line B-B. As shown in FIGS. 2-4, the plurality of through holes 26 has the same hole area and is symmetrically arranged relative to the frame hook 24 with the intervals gradually increasing along the side frame portion 22. A width W1 of each through hole 26 could be preferably not greater than a width W2 of the frame hook 24. In this embodiment, as shown in FIG. 3, the width W2 of the frame hook 24 corresponds to a sum of the widths of three through holes 26 (i.e., the width W1 of each through hole 26 is smaller than the width W2 of the frame hook 24), but not limited thereto, meaning that the sizes and number of the through holes 26 may vary depending on the actual manufacturing requirements of the front frame 16. For example, the present invention could also adopt a width design in which the width W1 of the through hole 26 is equal to the width W2 of the frame hook 24.

Via the aforesaid design, after hook engagement between the front frame 16 and the back cover 18 is completed, no matter the frame hook 24 is pulled or pressed to deform by the cover hook 28, as shown in FIG. 4, since the cross-sectional areas of the intervals between the plurality of through holes 26 increases gradually outward relative to the frame hook 24 (that is, the cross-sectional area of the interval near the force-bearing position of the frame hook 24 is smaller, and the cross-sectional area of the interval far from the force-bearing position of the frame hook 24 is larger), the connection frame portion 20 receives less force transmission at corresponding force-bearing positions close to the frame hook 24, and the connection frame portion 20 receives more force transmission at corresponding force-bearing positions far from the frame hook 24. As such, the stress concentration in the connection frame portion 20 can be dispersed when the frame hook 24 is pulled or pressed to deform by the cover hook 28. To be noted, in FIG. 4, the number of force transmissions F is used to simply illustrate the force transmission of the connection frame portion 20, which means the fewer the number of force transmissions F in the cross-sectional area of the interval, the less force transmission the connection frame portion 20 receives. In such a manner, deformation (e.g., wave-like deformation) of the transparent sheet 14 caused by the frame hook 24 can be reduced. As such, the present invention can effectively solve the prior art problem that light leakage of the display panel easily occurs at the positions corresponding to deformation of the frame hook, thereby greatly improving the image display quality of the display device.

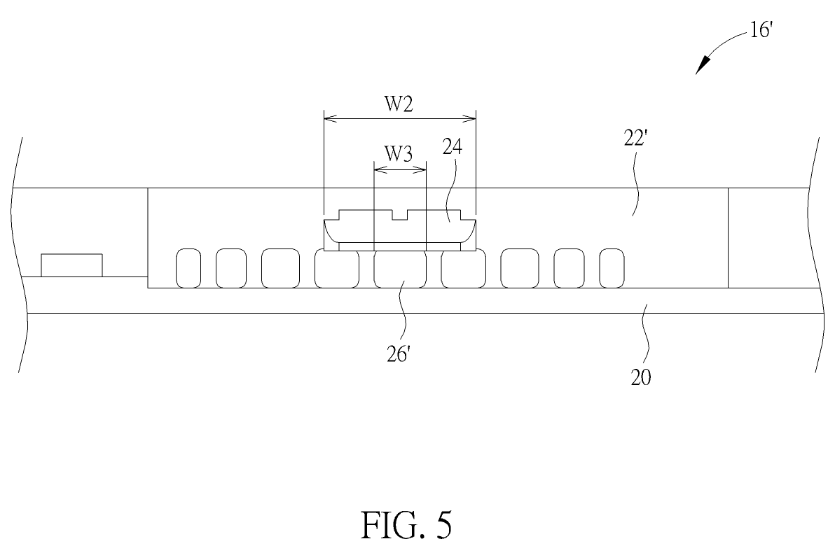

It should be mentioned that the hole arrangement design of the present invention is not limited to the aforementioned embodiment. For example, please refer to FIG. 5, which is a partially-enlarged diagram of a front frame 16' according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 5, the front frame 16' includes the connection frame portion 20 and a side frame portion 22'. The side frame portion 22' includes the frame hook 24 and a plurality of through holes 26' (nine shown in FIG. 5, but not limited thereto, meaning that the number of through holes may vary depending on the actual manufacturing requirements of the front frame 16') formed between the frame hook 24 and the connection frame portion 20. The plurality of through holes 26’ has the same interval and is arranged symmetrically relative to the frame hook 24 with hole areas gradually decreasing along the side frame portion 22’, wherein a width W3 of the through hole 26’ with a largest hole area (i.e., the through hole 26’ aligned with a center of the frame hook 24) is less than or equal to the width W2 of the frame hook 24. As shown in FIG. 5, via this gradually-decreasing hole area design, the front frame 16' can provide a similar stress distribution effect as shown in FIG. 4. In another embodiment, the plurality of through holes 26 could be disposed between the frame hook 24 and the connection frame portion 20 without being disposed below the frame hook 24, meaning that the plurality of through holes 26 could be only disposed on both sides of a region between the frame hook 24 and the connection frame portion 20 (not shown in the figures). In another embodiment, the plurality of through holes 26 could be only disposed directly below the frame hook 24, that is, at a center region between the frame hook 24 and the connection frame portion 20.

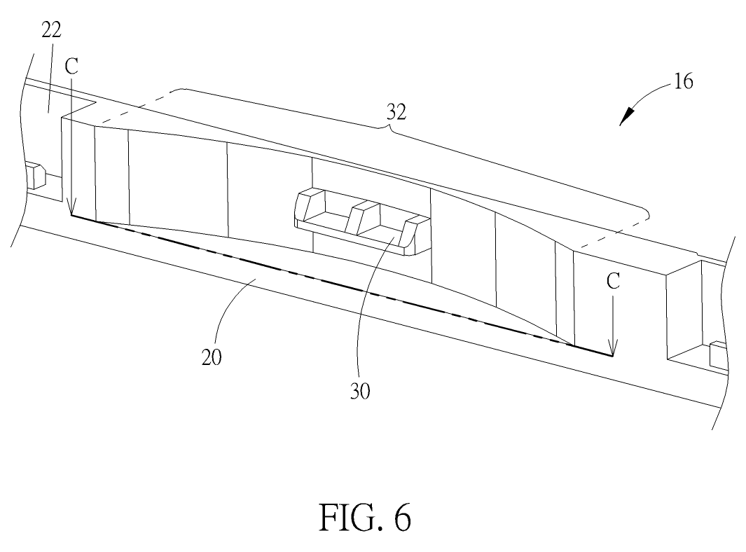

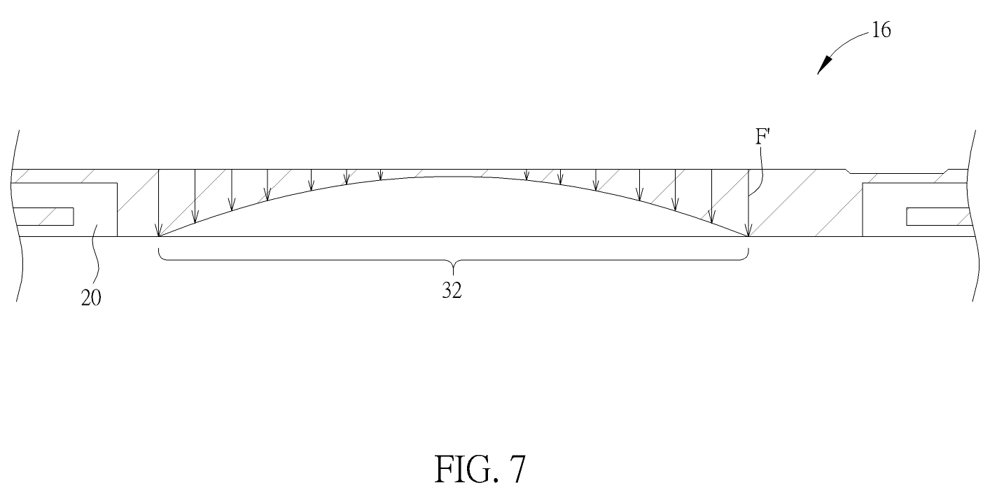

In addition to the above through-hole design, the present invention could also adopt a recessed frame design. For example, please refer to FIGS. 1, 6, and 7. FIG. 6 is a partially-enlarged diagram of the front frame 16 corresponding to a frame hook 30. FIG. 7 is a cross-sectional diagram of the front frame 16 in FIG. 6 along a cross-sectional line C-C. As shown in FIGS. 6 and 7, the side frame portion 22 includes a recessed section 32 formed at a position corresponding to another cover hook 28. The frame hook 30 is positioned on a side of the recessed section 32 opposite to the display module 12 and faces the back cover 18. A thickness of the recessed section 32 gradually decreases from two ends of the recessed section 32 toward the frame hook 30. To be more specific, in this embodiment, the thickness of the recessed section 32 could gradually decrease from the two ends of the recessed section 32 toward the frame hook 30 to make the recessed section 32 in an elliptical recessed shape, but not limited thereto, meaning that the present invention could adopt other recessed shape designs, such as a curved, sloped, or stepped recessed shape.

Via the aforesaid recessed frame design, after hook engagement between the front frame 16 and the back cover 18 is completed, no matter whether the frame hook 30 is pulled or pressed to deform by the cover hook 28, as shown in FIG. 7, since the thickness of the recessed section 32 gradually decreases from the two ends of the recessed section 32 toward the frame hook 30, the connection frame portion 20 receives less force transmission at corresponding force-bearing positions close to the frame hook 30, and the connection frame portion 20 receives more force transmission at corresponding force-bearing positions far from the frame hook 30. As such, the stress concentration in the connection frame portion 20 can be dispersed when the frame hook 30 is pulled or pressed to deform by the cover hook 28. To be noted, in FIG. 7, a length of a force transmission F' is used to briefly illustrate the force transmission of the connection frame portion 20, which means the shorter the length of the force transmission F', the less force transmission the connection frame portion 20 receives. In such a manner, the bending deformation (e.g., wave-like deformation) of the transparent sheet 14 caused by the deformation of the frame hook 30 can be reduced. As such, the present invention can effectively solve the prior art problem that light leakage of the display panel easily occurs at the positions corresponding to deformation of the frame hook, thereby greatly improving the image display quality of the display device.

To be noted, the aforesaid through-hole designs and the recessed frame designs could be implemented independently or combined on the front frame to enhance the structural design flexibility of the front frame of the present invention. For example, in another embodiment, the plurality of through holes 26, which is arranged with gradually-increasing intervals along the recessed section 32 of the frame portion 22, could be disposed between the frame hook 30 and the connection frame portion 20 as shown in FIG. 6, so as to further enhance the stress dispersion effect of the recessed section 32. As for other derived embodiments (e.g., an embodiment that simultaneously adopts the hole width decreasing design and the recessed frame design), the related description could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a display module;
a transparent sheet;
a front frame accommodating the display module and comprising a connection frame portion and a side frame portion, the connection frame portion being attached to the transparent sheet to make the transparent sheet cover a front surface of the display module, the side frame portion comprising a frame hook protruding outwardly relative to the display module, the side frame portion forming a plurality of through holes between the frame hook and the connection frame portion, and the plurality of through holes being formed at intervals along the side frame portion; and
a back cover disposed on a back surface of the display module and accommodating the front frame, the back cover comprising a cover hook protruding inwardly corresponding to the frame hook, and the frame hook being engaged with the cover hook.

2. The display device of claim 1, wherein the plurality of through holes has the same hole area and is arranged symmetrically relative to the frame hook with the intervals gradually increasing along the side frame portion.

3. The display device of claim 2, wherein a width of each through hole is less than or equal to a width of the frame hook.

4. The display device of claim 1, wherein the intervals are the same, and the plurality of through holes is arranged symmetrically relative to the frame hook with hole areas gradually decreasing along the side frame portion.

5. The display device of claim 4, wherein a width of the through hole with a largest hole area is less than or equal to a width of the frame hook.

6. The display device of claim 1, wherein the side frame portion comprises a recessed section corresponding to the cover hook, the frame hook is positioned on a side of the recessed section opposite to the display module and faces the back cover, and a thickness of the recessed section gradually decreases from two ends of the recessed section toward the frame hook.

7. The display device of claim 6, wherein the thickness of the recessed section gradually decreases from the two ends of the recessed section toward the frame hook to make the recessed section in a curved, sloped, or stepped recessed shape.

8. The display device of claim 7, wherein the thickness of the recessed section gradually decreases from the two ends of the recessed section toward the frame hook to make the recessed section in an elliptical recessed shape.

9. A display device comprising:
a display module;
a transparent sheet;
a back cover disposed on a back surface of the display module, a cover hook protruding laterally from the back cover toward the display module; and
a front frame stacked with the back cover and accommodating the display module, the front frame comprising a connection frame portion and a side frame portion, the connection frame portion being attached to the transparent sheet to make the transparent sheet cover a front surface of the display module, the side frame portion comprising a recessed section and a frame hook corresponding to the cover hook, the frame hook being positioned on a side of the recessed section opposite to the display module and facing the back cover, a thickness of the recessed section gradually decreasing from two ends of the recessed section toward the frame hook, and the cover hook being engaged with the frame hook.

10. The display device of claim 9, wherein the thickness of the recessed section gradually decreases from the two ends of the recessed section toward the frame hook to make the recessed section in a curved, sloped, or stepped recessed shape.

11. The display device of claim 10, wherein the thickness of the recessed section gradually decreases from the two ends of the recessed section toward the frame hook to make the recessed section in an elliptical recessed shape.

12. A front frame for being engaged with a back cover and attached to a transparent sheet to accommodate a display module, the back cover being disposed on a back surface of the display module and comprising a cover hook protruding laterally toward the display module, the front frame comprising:
a connection frame portion attached to the transparent sheet to make the transparent sheet cover a front surface of the display module; and
a side frame portion comprising a frame hook corresponding to the cover hook and forming a plurality of through holes between the frame hook and the connection frame portion, the plurality of through holes being formed at intervals along the side frame portion, and the frame hook being engaged with the cover hook.

13. The front frame of claim 12, wherein the plurality of through holes has the same hole area and is arranged symmetrically relative to the frame hook with the intervals gradually increasing along the side frame portion.

14. The front frame of claim 13, wherein a width of each through hole is less than or equal to a width of the frame hook.

15. The front frame of claim 12, wherein the intervals are the same, and the plurality of through holes is arranged symmetrically relative to the frame hook with hole areas gradually decreasing along the side frame portion.

16. The front frame of claim 15, wherein a width of the through hole with a largest hole area is less than or equal to a width of the frame hook.

17. The front frame of claim 12, wherein the side frame portion comprises a recessed section corresponding to the cover hook, the frame hook is positioned on a side of the recessed section opposite to the display module and faces the back cover, and a thickness of the recessed section gradually decreases from two ends of the recessed section toward the frame hook.

18. The front frame of claim 17, wherein the thickness of the recessed section gradually decreases from the two ends of the recessed section toward the frame hook to make the recessed section in a curved, sloped, or stepped recessed shape.

19. The front frame of claim 12, wherein the plurality of through holes is only disposed on both sides of a region between the frame hook and the connection frame portion.

20. The front frame of claim 12, wherein the plurality of through holes is only disposed in a region between the frame hook and the connection frame portion.
